(19) United States
(12) Patent Application Publication
(10) Pub. No.: US 2022/0000584 A1
(43) Pub. Date: Jan. 6, 2022

(54) DENTAL SPLINT

(71) Applicant: Université De Genève, Genève (CH)

(72) Inventors: Irena Sailer, Genève (CH); Felix Burkhardt, Solothurn (CH); Hyeonjong Lee, Seoul (KR)

(21) Appl. No.: 17/296,782

(22) PCT Filed: Nov. 13, 2019
(86) PCT No.: PCT/EP2019/081237

§ 371 Date: May 25, 2021

(30) Foreign Application Priority Data
Nov. 26, 2018 (EP) 18208342.8

(51) Int. Cl. A61C 7/08; B33Y 80/00

(52) U.S. Cl. CPC A61C 7/08; B33Y 80/00

(57) ABSTRACT

The present relates to a dental splint (1) comprising a plurality of stamp portions (11) each of them being adapted to receive a predetermined quantity of reconstructive material (14) and to be placed on a predetermined tooth, a base support portion (13) for supporting the stamp portions (11) and a leg portion (12) linking each stamp portion (11) to the base support portion (13), characterized in that each stamp portion (11) presents a surface (111) adapted to cover the area of the tooth where material (14) has to be added only.

### TECHNICAL FIELD

The present invention relates to a medical device and more particularly to a dental splint for standardized and predictable application of plastic reconstructive material on tooth surfaces.

### BACKGROUND OF THE ART

In the current practice of dentistry, clinicians often attempt to treat problems of compromised teeth that lost varying amounts of tooth substance. Such defects can be caused by caries or fractures of teeth, or by abrasively and/or erosively worn teeth. One common approach to treating the problem of loss of tooth substance is the use of splints which are means to cover the teeth and which are used as support to provide reconstructive resin onto the teeth.

A typical type of dental splint has a U-shaped base and channel-forming wall-shaped reinforcements on the tongue and lip sides as shown in FIGS. 1 and 2. A problem with these splints is the fact that they entirely cover the tooth thereby preventing access to the tooth and that they are made out of soft materials thereby leading to a very bad stabilization on the teeth.

An example of such conventional dental splint is disclosed in WO 2016/066552 showing a dental splint to be placed onto the teeth with resin to reconstruct the teeth. The problem of this splint is that it surrounds the teeth thereby preventing access to the teeth once in place. Also, since it is surrounding the teeth, it must be in soft material because otherwise it could not be taken off. Further in order to provide stabilization, it presents a support element 554 in contact with the teeth. Because of this tip 554, a second step of filling the hole (former space used by the tip) is needed.

It is, accordingly, an object of the present invention to provide an improved rigid splint and splinting method with good access for the removal of restorative material excess that requires minimal preparation and minimal bonding.

In this regard, a primary object of the invention is to solve the above-mentioned problems and more particularly to provide a dental splint presenting easy handling, easy access to the teeth while in position and improved stabilization.

### SUMMARY OF THE INVENTION

The above problems are solved by the present invention.

A first aspect of the invention is a dental splint comprising a plurality of stamp portions each of them being adapted to receive a predetermined quantity of reconstructive material and to be placed on a predetermined tooth, a base support portion for supporting the stamp portions and a leg portion linking each stamp portion to the base support portion, characterized in that each stamp portion presents a surface adapted to cover the area of the tooth where material has to be added only. In this manner, only the necessary tooth surface is covered and free access is available for example for the dentist to remove the excess resin.

Preferably, the dental splint further comprises at least a distal stamp portion and a proximal stamp portion acting as stops and overlapping an occlusal surface of its respective teeth to the vestibular/lingual and distal/mesial directions to assure stabilization. In this manner, stabilization of the splint is enhanced.

In a preferred manner, the dental splint further comprises at least one intermediate stamp portion acting as stop.

According to a preferred embodiment of the present invention, the dental splint is composed of a stiff transparent resin. Therefore, the splint resin doesn't allow any bending or deformation while placing

Advantageously, each leg portion consist in one or more solid bars. Therefore, one permits a secure placement and light weight.

Preferably, the number of solid bars in each leg portion ranged from one to three bars depending on the area of the stamp portion. Therefore, each stamp portion is well designed to be stabilized.

According to a preferred embodiment of the present invention, the solid bars are cylindrical. The weight is further reduced.

Advantageously, the stamp portion comprises a weak region presenting a breaking line. Therefore, the splint can be retired used after reconstruction of a portion below the tooth's equator.

According to a preferred embodiment of the present invention, the breaking line is disposed on or above the equator of the new designed tooth.

Preferably, the base support portion has a rectangular cross shape. Therefore, handling is improved.

Advantageously, each stamp portion is individual and separated from its adjacent stamp portion. Therefore, even more space is free between the teeth, thereby allowing more access.

A second aspect of the invention is a dental splint manufacturing method comprising the steps of scanning at least a portion of an intraoral area including the teeth of a patient, designing a reconstructed shape of each tooth, determining a quantity of reconstructive material for each designing an onlay shape structure taking into account a quantity of reconstructive material to be received on each stamp of the onlay, fabricating the dental splint using 3D printing. The particular advantages of this device of the invention being similar to the ones of the method of the first aspect of the invention, they will not be repeated here.

### BRIEF DESCRIPTION OF THE DRAWINGS

Further particular advantages and features of the invention will become more apparent from the following non-limitative description of at least one embodiment of the invention which will refer to the accompanying drawings, wherein

FIG. 1 represents a dental splint of the prior art,

FIG. 2 represents a cross section view of the stamp portion of the prior art,

FIG. 3 schematically represent a dental splint of the present invention,

FIG. 4 schematically represent a cross section view of a stamp portion of the present invention,

FIGS. 5 and 6 shows perspective views of a dental splint of the present invention.

### DETAILED DESCRIPTION OF THE INVENTION

The present detailed description is intended to illustrate the invention in a non-limitative manner since any feature of an embodiment may be combined with any other feature of a different embodiment in an advantageous manner.

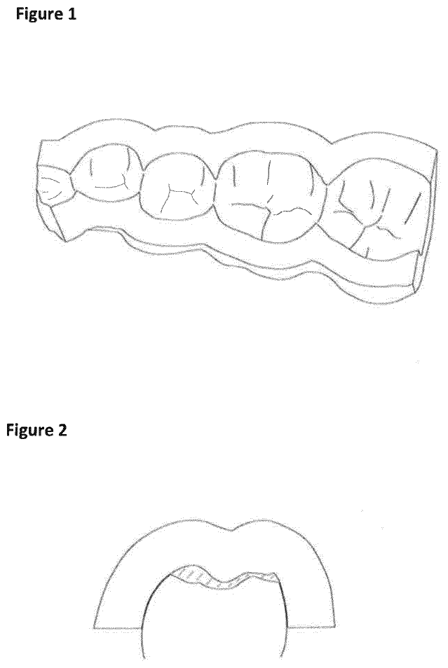

FIG. 1 and FIG. 2 show the prior art dental splint discussed above.

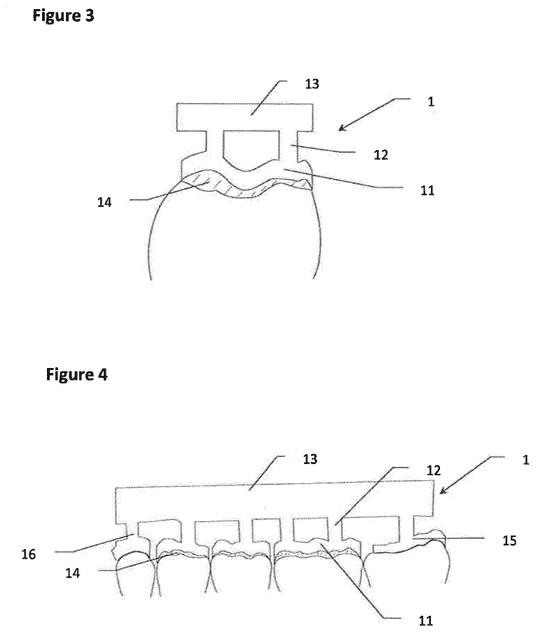

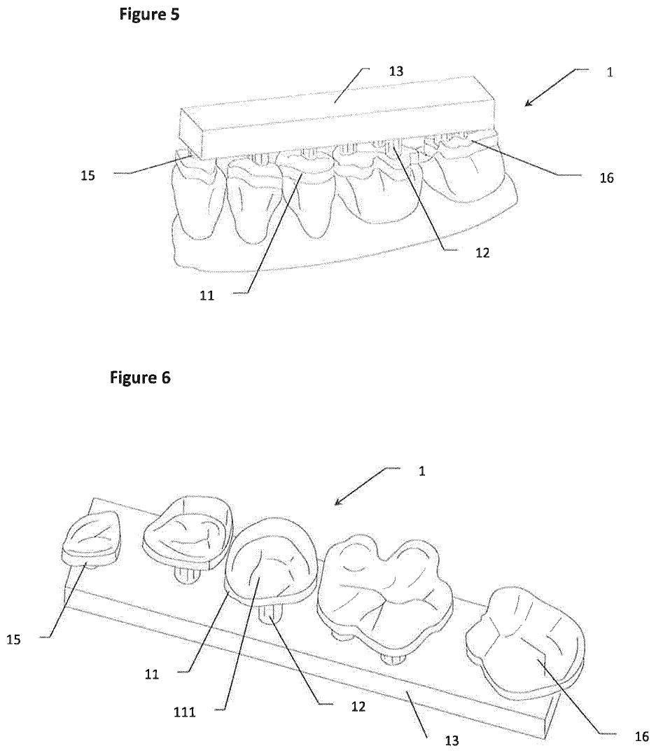

FIGS. 3-6 show an aspect of the invention which is a dental splint 1 composed of a stiff transparent material such as resin, milling or printing material or the same comprising a plurality of stamp portions 11 each of them being adapted to receive a predetermined quantity of reconstructive material 14 and to be placed on a predetermined tooth, a base support portion 13, preferably having rectangular cross shape, for supporting the stamp portions 11 and a leg portion 12, consisting in one or more cylindrical, solid bars, preferably from one or more, such as two, three or even more bars depending on the area 111 of the stamp portion 11, linking each stamp portion 11 to the base support portion 13, characterized in that each stamp portion 11 presents a surface 111 adapted to cover the area of the tooth where material 14 has to be added only. In this manner, only the necessary tooth surface is covered and free access is available for example for the dentist to remove the excess resin 14.

In order to assure stabilization, the dental splint 1 further comprises at least a distal stamp portion 15 and a proximal stamp portion 16 and possibly at least one intermediate stamp portion acting as stop, acting as stops and overlapping an occlusal surface of its respective teeth to the vest/ling and distal/mesial directions. In this manner, stabilization of the splint is enhanced.

Although not represented, the stamp portion 11 can comprise a weak region presenting a breaking line. This is especially the case when the stamp portion 11 is such that it has to surround its tooth because, for example, it has to be so much reconstructed that the stamp portion needs to go below the equator line (below the bulky portion of the tooth) of the tooth. Thus, the breaking line is disposed on the equator of the tooth so that the splint can be taken off after reconstruction of the portion below the tooth's equator.

Advantageously, as shown in the figures, each stamp portion 11 is individual and separated from its adjacent stamp portion. Therefore, even more space is free between the teeth, thereby allowing more access.

A second aspect of the invention is a dental splint manufacturing method comprising the steps of scanning at least a portion of an intraoral area including the teeth of a patient, designing a reconstructed shape of each tooth, determining a quantity of reconstructive material for each designing an onlay shape structure taking into account a quantity of reconstructive material to be received on each stamp of the only, fabricating the dental splint using 3D printing.

While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the scope of this disclosure. This for example particularly the case regarding the material which can be used and the number of stamp portions.

1-14. (canceled)

15. Dental splint comprising:
a plurality of stamp portions each being adapted to receive a predetermined quantity of reconstructive material and to be placed on a predetermined tooth;
a base support portion for supporting the stamp portions; and
a leg portion linking each stamp portion to the base support portion;
wherein each stamp portion presents a surface adapted to cover an area of the tooth where material has to be added only.

16. Dental splint according to claim 15, further comprising at least a distal stamp portion and a proximal stamp portion acting as stops and overlapping an occlusal surface of its respective teeth to a vestibular/lingual and distal/mesial directions to assure stabilization.

17. Dental splint according to claim 16, further comprising at least one intermediate stamp portion acting as stop.

18. Dental splint according to claim 15, composed of a stiff transparent resin.

19. Dental splint according to claim 15, wherein each leg portion comprises or consists of one or more solid bars.

20. Dental splint according to claim 19, wherein a number of solid bars in each leg portion ranges from one to three bars depending on the area of the stamp portion.

21. Dental splint according to claim 20, wherein the solid bars are cylindrical.

22. Dental splint according to claim 15, wherein the stamp portion comprises a weak region presenting breaking line.

23. Dental splint according to claim 22, wherein a breaking line is disposed on or above the equator of the new designed tooth.

24. Dental splint according to claim 15, wherein the base support portion has a rectangular cross shape.

25. Dental splint according to claim 15, wherein each stamp portion is individual and separated from its adjacent stamp portion.

26. Dental splint manufacturing method comprising the steps of:
scanning at least an intraoral portion of the teeth of a patient,
designing an onlay shape structure taking into account a quantity of reconstructive material to be received on each stamp of the onlay,
fabricating the dental splint using a computer aided manufacturing method.

27. Dental splint manufacturing method according to claim 26, wherein the computer aided manufacturing method is 3D-printing.

28. Dental splint manufacturing method according to claim 26, wherein the computer aided manufacturing method is milling.
